(19) United States
(12) Patent Application Publication
(10) Pub. No.: US 2026/0244499 A1
(43) Pub. Date: Aug. 20, 2026

(54) Selective Throttling of Workflow Tools

(71) Applicant: Alteryx, Inc., Irvine, CA (US)

(72) Inventors: Christopher H. Kingsley, Longmont, CO (US); Roman Savchenko, Prague (CZ); Kostiantyn Shpuryk, Prague (CZ)

(73) Assignee: Alteryx, Inc., Irvine, CA (US)

(21) Appl. No.: 19/055,890

(22) Filed: Feb. 18, 2025

(51) Int. Cl. G06F 9/50

(52) U.S. Cl. CPC G06F 9/5027

(57) ABSTRACT

Selective throttling of workflow tools is described. A computing device receives a workflow configured to generate an output by processing data using a plurality of tools, which include one or more upstream tools and one or more downstream tools. Execution of the workflow involves generating tasks using the one or more upstream tools, maintaining the tasks in a queue, and releasing individual tasks from the queue to appropriate downstream tools. During the execution of the workflow, the computing device monitors the queue and detects when at least one throttle threshold condition is satisfied. In response to satisfaction of a throttle threshold condition, at least one upstream tool is throttled to reduce tasks generated by the tool. When a resume threshold condition is satisfied, the computing device resumes the throttled tool. The computing device continues to monitor workflow queues and selectively throttles/resumes workflow tools until execution of the workflow is complete.

### BACKGROUND

With advances in computing device technology, workflow management in computing environments faces a significant challenge in efficiently executing complex, multi-stage tasks while optimizing resource utilization. Workflow management has become increasingly important due to the growing reliance on interconnected systems to process large volumes of data and perform diverse operations in workflows involving tasks that must be completed atomically, tasks that are permitted to be performed in parallel, and combinations thereof. The ability to dynamically manage and prioritize tasks within workflows is crucial for maintaining computing system performance and ensuring cost-effective resource allocation.

### SUMMARY

Selective throttling of workflow tools is described. In implementations, a computing device receives a workflow configured to generate an output by processing data using a plurality of tools. The plurality of tools include one or more upstream tools and one or more downstream tools, where the upstream tools are configured to generate tasks for subsequent execution by one or more of the downstream tools. The computing device executes the workflow by first generating the tasks using the one or more upstream tools. These generated tasks are then maintained in a queue. The output is generated by releasing individual tasks from the queue to the appropriate tools among the one or more downstream tools. During the execution of the workflow, the computing device monitors the queue and detects when at least one throttle threshold condition is satisfied due to the tasks being maintained in the queue. When a throttle threshold condition is detected, the computing device responds by throttling at least one tool among the one or more upstream tools. The computing device continues to monitor the queue and detects when a resume threshold condition is satisfied (e.g., due to tasks being removed from the queue responsive to execution by one or more of the downstream tools). In response to detecting the resume threshold condition, the computing device resumes or “unthrottles” the previously throttled tool. The computing device continues to monitor workflow queues and selectively throttles/resumes workflow tools to optimize performance until execution of the workflow is complete.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the selective workflow tool throttling techniques described herein.

FIG. 2 depicts a system in an example implementation showing operation of executing a workflow in accordance with the techniques described herein.

FIG. 3 depicts a system illustrating an example workflow structure with multiple interconnected tools and task queues.

FIG. 4 depicts a system in an example implementation showing operation of the scheduler as selectively throttling and resuming tools during execution of a workflow.

FIG. 5 depicts a procedure in an example implementation of selectively throttling workflow tools during execution of a workflow.

FIG. 6 illustrates an example system that includes an example computing device that is representative of one or more computing systems and/or devices that implement the various techniques described herein.

### DETAILED DESCRIPTION

With advances in computing device technology, increasingly complex workflows are generated to perform computational tasks. In accordance with the techniques described herein, a workflow refers to one or more sequences of interconnected tools that collectively operate to achieve one or more objectives (e.g., generate at least one output by processing data). For example, a workflow may include data ingestion tools to obtain data from one or more data storage locations, processing tools to manipulate the data according to defined algorithmic steps, analysis tools to generate insights based on input data, reporting tools to produce an output in a defined format, and so forth.

Workflows are often created using programming languages, where a workflow author (e.g., an application developer) writes instructions for each workflow tool that are executed by a computing device to preform functionality of the corresponding tool. In some implementations, workflows are developed using a graphical programming language where authoring users are provided with palettes of tools that can be dragged onto a canvas and connected with one another to create a workflow without having to manually author code for executing functionality of the corresponding tools.

Individual tools of a workflow often generate outputs in the form of tasks that need to be subsequently executed by one or more different tools of the workflow in order to achieve a desired objective. For instance, as a simple example, consider a workflow involving three tools: a first tool to obtain encrypted data from one or more data storage locations and decrypt the data, a second tool to sort the data according to defined arrangement criteria, and a third tool to generate an output report that presents the sorted data in a defined format. In this example, an entirety of the unencrypted data must be available for the second tool to analyze before it can begin sorting, such that the second tool cannot begin performing its functionality until the first tool has completed its data decryption. Continuing this example implementation, an output by the first tool can be regarded as a task to be performed by the second tool, where this task is held (e.g., in a queue) until the first tool is finished. Thus, relative to the task as held in the queue, the first tool is regarded as an upstream tool and the second tool is regarded as a downstream tool.

Thus, as described herein, the terms “upstream tools” and “downstream tools” in workflow management do not refer to a fixed, linear ordering of tools, but rather describe their logical relationship to a task queue that serves as an intermediary buffer for holding tasks until they can be executed (e.g., based on computational resource availability, based on conditions that require waiting for other tools to finish processing, combinations thereof, and so forth). Upstream tools are considered “upstream” because they produce work that flows towards the queue, regardless of their position in the overall workflow sequence.

Conversely, downstream tools consume and execute the tasks held in the queue, receiving work that flows from the queue. This queue-centric perspective allows for complex, non-linear workflow structures, including parallel processing, branching workflows, and feedback loops. In implementations, a workflow tool's role as upstream or downstream might change dynamically depending on the specific operation being performed. For instance, in one scenario, Tool A might generate tasks for Tool B (making A upstream and B downstream), while in another scenario during the same workflow, roles of Tool A and Tool B are reversed. In some implementations, a workflow involves multiple queues, where a given tool is downstream relative to one queue and upstream relative to another queue.

Given the complexity of different workflows that can be created to accomplish different objectives, workflow management faces a significant challenge in efficiently executing complex, multi-stage workflows while optimizing resource utilization, particularly when workflows are executed using distributed computing environments. Workflow management has become increasingly important due to the growing reliance on interconnected systems to process large volumes of data and perform diverse operations involving tasks that must be completed atomically, tasks that are permitted to be performed in parallel, and combinations thereof. The ability to dynamically manage and prioritize tasks within workflows is crucial for maintaining computing system performance and ensuring cost-effective resource allocation.

Conventional approaches to workflow management lack the ability to exercise fine-grained control over tool execution rates, involve inefficient resource utilization across different workflow stages, and suffer from an inability to dynamically adjust generation and execution of workflow tasks based on real-time system conditions. Traditional workflow management tools struggle to balance the processing of tasks with varying resource requirements, leading to bottlenecks and suboptimal performance. Additionally, given the complexity of modern workflows, with their multiple dependencies and varying priorities, it remains challenging to implement effective task prioritization and resource allocation strategies.

For instance, in implementations where certain tasks consume disproportionate amounts of processing power or memory, conventional workflow management approaches fail to adequately throttle these resource-intensive operations, resulting in overall workflow slowdowns. When dealing with workflows where concurrent tools compete for shared resources (e.g., processing devices, memory, etc.) to complete respective tasks, conventional systems lack the capability to intelligently distribute resources across different tools, leading to inefficiencies and conflicts in resource allocation. Thus, there remains a need for workflow management approaches that adapt to dynamic computing environments.

To address these conventional shortcomings, selective throttling of workflow tasks is described. In implementations, a computing system receives a workflow comprised of a plurality of tools that are collectively configured to perform a computational task by processing data, as generally described above. The computing system is configured to perform the computational task by executing code (e.g., using one or more processing devices) corresponding to each tool in the workflow. During execution of the workflow, the computing system is configured to maintain at least one queue for storing tasks to be completed by one or more workflow tools as part of executing the workflow. During execution of a workflow, data output by a first workflow tool is used as input for a second workflow tool in order for the second workflow tool to perform its respective functionality in completing the computational task. In many hardware architectures, different workflow tools share hardware resources (e.g., processor cores, compute units, cache storage, etc.) when performing their respective functionalities, such that tools otherwise permitted to execute in parallel are unable to do so based on computational resource constraints.

Alternatively or additionally, some workflow tools require atomicity. As described herein, “atomicity” refers to indivisible operations that are required to be performed serially and without interruption (e.g., a database transaction that must either complete entirely or not occur at all, ensuring data consistency even if underlying hardware fails during execution). Given hardware resource constraints, atomicity requirements, and other considerations, workflow execution necessitates that certain tasks (e.g., data and corresponding instructions for processing the data) be maintained in the queue until downstream tools are available and/or permitted to execute the queued tasks.

To enable the techniques described herein, a computing system includes a scheduler, which represents functionality of the computing system to release tasks from the queue for execution by one or more downstream workflow tools. The scheduler, for instance, monitors the queue and available hardware resources of the computing system to identify when hardware resources are available for allocation to a downstream tool, such that the downstream tool is capable of executing a queued task.

When too many tasks accumulate in a queue, several problems can arise that impact system performance and efficiency. As a number of queued workflow tasks grows, the queued tasks may exceed the capacity of rapidly accessible data storage locations like cache systems, forcing the system to rely on slower main memory for task storage. This transition from cache to main memory increases access times and requires additional computational resources, leading to slower task execution and reduced overall workflow efficiency. Furthermore, maintaining an excessive number of tasks in queue consumes valuable memory resources that could be better utilized for other workflow tools, critical system operations, and so forth.

At a certain point, the computational overhead of managing and accessing a large queue outweighs the benefits of executing upstream tools to generate tasks that are sent to the queue. This inefficiency manifests as increased memory management operations, higher latency in task retrieval, and potential system slowdowns due to memory pressure. Additionally, a bloated queue can lead to outdated or stale tasks if the workflow conditions change rapidly, potentially resulting in wasted processing of irrelevant tasks. Therefore, it becomes computationally wasteful to continue queuing additional tasks beyond an optimal threshold, as the marginal benefit of having more pre-generated tasks is outweighed by the increased system overhead and potential for resource contention.

To account for these problems, the scheduler is configured to monitor the queue relative to one or more throttle threshold conditions. As described herein, throttle threshold conditions refer to criteria that, when detected, trigger the scheduler to throttle one or more upstream workflow tools to manage task generation and queue growth. These throttle threshold conditions are configurable based on a range of factors related to the task queue and underlying system resources of a computing system executing the workflow. For instance, in an example implementation a throttle threshold condition specifies a predetermined limit of tasks permitted to be maintained in the queue (e.g., to prevent memory overload).

Alternatively or additionally, a throttle threshold condition specifies a total data size of queued tasks, initiating throttling when the queue consumes more than a threshold amount of memory. Alternatively or additionally, system resource utilization serves as a throttle threshold condition, such as throttling upstream tools when available processing device usage exceeds a defined percentage, when available memory drops below a threshold percentage, combinations thereof, and so forth. Alternatively or additionally, throttle threshold conditions include time-based thresholds, triggering throttling if tasks remain in the queue for longer than a specified duration, indicating potential processing bottlenecks. Alternatively or additionally, throttle threshold conditions include temperature thresholds, such that a temperature of a computing system component triggers throttling of a workflow tool to prevent system damage. Alternatively or additionally, custom thresholds are configurable based on workflow-specific metrics, such as throttling when the ratio of incoming tasks to outgoing tasks (e.g., relative to the queue) exceeds a certain value, indicating an imbalance in task generation and consumption rates. These examples are merely illustrative and not intended to limit throttle thresholds in accordance with the techniques described herein.

In response to detecting occurrence of a throttle threshold condition, the scheduler is configured to identify an upstream workflow tool contributing to occurrence of the throttle threshold condition and throttle the identified tool to reduce an amount of tasks being generated and sent to the queue. In implementations, the scheduler employs various strategies to identify upstream workflow tools contributing to throttle threshold conditions. In one example implementation, the scheduler analyzes task generation rates of individual upstream tools and compares the task generation rates to determine which tool is producing tasks at a disproportionately high rate relative to others.

Alternatively or additionally, the scheduler is configured to examine metadata associated with queued tasks, allowing the scheduler to pinpoint tools contributing most significantly to queue congestion. Alternatively or additionally, the scheduler considers the computational complexity or resource requirements of tasks generated by different tools, prioritizing the identification of tools producing resource-intensive tasks that strain system capabilities. Alternatively or additionally, historical performance data is utilized to identify tools that have previously led to satisfaction of throttle threshold conditions (e.g., during prior execution of workflows involving similar tools). Alternatively or additionally, the scheduler is configured to take into account the relative importance or priority of different workflow stages, focusing on non-critical path tools when possible to minimize impact on overall workflow performance.

Alternatively or additionally, the scheduler is configured to employ machine learning algorithms to predict which tool's throttling would most effectively alleviate queue congestion based on current workflow patterns and system state. Alternatively or additionally, the scheduler is configured to analyze current system resource utilization associated with each tool's operation, identifying tools consuming excessive resources as potential candidates for throttling. These varied approaches enable the scheduler to adaptively identify and manage upstream tools contributing to throttle conditions, optimizing workflow execution in diverse computing environments. In response to identifying one or more tools contributing to satisfaction of the throttling threshold condition, the scheduler throttles the identified tool(s).

In accordance with the described techniques, throttling of workflow tools can be implemented in diverse ways depending on specific workflow requirements and system constraints. In some implementations, throttling involves pausing the operation of an upstream tool, temporarily halting its task generation until system conditions improve. Alternatively, throttling is applied by reducing a rate at which a tool generates tasks, allowing the tool to continue functioning at a limited pace. This rate reduction may be achieved by introducing delays between task generations, limiting the number of tasks the tool can produce within a given time limit, adjusting internal parameters that control the tool's processing speed, combinations thereof, and so forth. The specific throttling approach implemented by the scheduler may depend on factors such as the nature of the workflow, the severity of the queue congestion, criticality of the tool's operations, combinations thereof, and so forth.

After throttling one or more upstream workflow tools, the scheduler continues to monitor the queue for satisfaction of resume threshold conditions. In implementations, resume threshold conditions may differ from throttle threshold conditions to prevent rapid oscillation between throttling and resuming operations. For instance, while a throttle threshold might trigger when the queue reaches 90% capacity, the corresponding resume threshold may be satisfied when the queue drops below 70% capacity, providing a buffer zone for system stability. Resume threshold conditions are configurable similar to throttle threshold conditions, such that any metric useable to trigger throttling a tool is useable to trigger resumption of the tool, and vice versa. Resume thresholds may also consider factors such as the rate of task consumption by downstream tools, available system resources, time elapsed since throttling was initiated, combinations thereof, and so forth. In some implementations, the scheduler is configured to employ adaptive algorithms to dynamically adjust resume thresholds based on observed system behavior and workflow patterns.

When resume threshold conditions are satisfied, the scheduler initiates the process of “unthrottling,” or resuming normal operation of previously throttled tools. This resumption may occur gradually, with the scheduler incrementally increasing the task generation rate of the throttled tool until it reaches its pre-throttled state. Alternatively, in some implementations the scheduler is configured to immediately restore a throttled tool to full operational capacity. The specific approach to resuming operations may depend on the nature of the workflow, the current system state, and the potential impact on overall workflow performance, combinations thereof, and so forth. Throughout workflow execution, the scheduler continues to monitor both throttle and resume thresholds, maintaining the ability to re-throttle tools as necessary to ensure optimal workflow execution and resource utilization.

The techniques are described herein with respect to a single workflow queue for simplicity of explanation, but are not so limited. In implementations, a workflow can be configured to include any number of queues, each serving as an intermediary buffer between different sets of upstream and downstream tools. The scheduler is configured to simultaneously monitor multiple queues within a single workflow, applying the described throttling and resuming techniques to upstream tools relative to each respective queue. This multi-queue capability allows for more complex workflow structures, such as those with parallel processing branches, nested sub-workflows, or hierarchical task management. In such scenarios, the scheduler dynamically assesses the state of each queue, considering factors such as queue size, task complexity, and resource utilization specific to the tools interacting with that queue.

The scheduler may implement queue-specific throttle and resume thresholds, allowing for fine-grained control over different workflow segments. This approach enables the system to optimize performance across various workflow stages concurrently, balancing task generation and execution across multiple queues to maintain overall workflow efficiency. The ability to manage multiple queues simultaneously enhances the system's adaptability to diverse and complex workflow architectures, ensuring efficient resource allocation and task management throughout the entire workflow execution process. Further discussion of these and other examples is included in the following description and illustrated with respect to the corresponding figures.

In some aspects, the techniques described herein relate to a method implemented by at least one computing device, the method including: receiving a workflow configured to generate an output by processing data using a plurality of tools, the plurality of tools including a set of upstream tools and a set of downstream tools, the set of upstream tools configured to generate tasks for subsequent execution by one or more tools included in the set of downstream tools; executing the workflow by: generating the tasks using the set of upstream tools; maintaining the tasks in a queue; and generating the output by releasing individual ones of the tasks in the queue to the one or more tools included in the set of downstream tools; and during the executing the workflow: detecting satisfaction of at least one throttle threshold condition due to maintaining the tasks in the queue; and throttling at least one tool in the set of upstream tools.

In some aspects, the techniques described herein relate to a method, wherein generating the tasks for subsequent execution by the one or more tools included in the set of downstream tools includes processing the data, wherein each of the tasks for subsequent execution by the one or more tools included in the set of downstream tools includes: at least one instruction to be executed by a processing device of the at least one computing device; and information describing at least some of the data involved in executing the at least one instruction.

In some aspects, the techniques described herein relate to a method, wherein each of the tasks for subsequent execution by the one or more tools included in the set of downstream tools is maintained in the queue with information describing a source tool in the set of upstream tools that generated the task.

In some aspects, the techniques described herein relate to a method, wherein throttling the at least one tool in the set of upstream tools includes identifying the at least one tool as causing satisfaction of the at least one throttle threshold condition based on the information describing, for each of the tasks maintained in the queue, a corresponding source tool that generated the task.

In some aspects, the techniques described herein relate to a method, wherein releasing individual ones of the tasks in the queue to the one or more tools included in the set of downstream tools is performed responsive to detecting that the at least one computing device includes sufficient available resources for executing the individual ones of the tasks.

In some aspects, the techniques described herein relate to a method, wherein the sufficient available resources include a threshold number of available processing devices.

In some aspects, the techniques described herein relate to a method, wherein the sufficient available resources include a threshold amount of memory allocated to the at least one computing device.

In some aspects, the techniques described herein relate to a method, wherein throttling the at least one tool in the set of upstream tools includes identifying the at least one tool in the set of upstream tools as disproportionately generating tasks relative to other tools of the set of upstream tools during execution of the workflow.

In some aspects, the techniques described herein relate to a method, wherein throttling the at least one tool in the set of upstream tools includes pausing the at least one tool in the set of upstream tools.

In some aspects, the techniques described herein relate to a method, wherein throttling the at least one tool in the set of upstream tools includes limiting an amount of tasks the at least one tool is permitted to generate or limiting a rate at which the at least one tool is permitted to generate tasks.

In some aspects, the techniques described herein relate to a method, wherein throttling the at least one tool in the set of upstream tools is performed independent of throttling other tools in the set of upstream tools.

In some aspects, the techniques described herein relate to a method, further including detecting satisfaction of at least one resume threshold and causing the at least one tool in the set of upstream tools to continue functioning without throttling in response to detecting satisfaction of the at least one resume threshold.

In some aspects, the techniques described herein relate to a method, wherein the at least one resume threshold includes one or more of: a number of tasks maintained in the queue; an amount of data required by the tasks maintained in the queue; a number of available processing devices; an amount of available memory; or a temperature of the at least one computing device.

In some aspects, the techniques described herein relate to a method, further including dynamically modifying the at least one resume threshold during the executing the workflow based on one or more of: a number of tools included in the set of upstream tools; a number of available processing devices; an amount of available memory; a distance between the throttled at least one upstream tool relative to the queue in the workflow; or a distance between at least one downstream tool in the set of downstream tools relative to the queue in the workflow.

In some aspects, the techniques described herein relate to a method, wherein the at least one throttle threshold condition includes one or more of: a number of tasks maintained in the queue; an amount of data required by the tasks maintained in the queue; a number of available processing devices; an amount of available memory; or a temperature of the at least one computing device.

In some aspects, the techniques described herein relate to a method, further including dynamically modifying the at least one throttle threshold condition during the executing the workflow based on one or more of: a number of tools included in the set of upstream tools; a number of available processing devices; an amount of available memory; a distance between the throttled at least one upstream tool relative to the queue in the workflow; or a distance between at least one downstream tool in the set of downstream tools relative to the queue in the workflow.

In some aspects, the techniques described herein relate to a method, further removing the individual ones of the tasks from the queue in response to releasing the individual ones of the tasks from the queue to the one or more tools included in the set of downstream tools.

In some aspects, the techniques described herein relate to a method, wherein the at least one resume threshold causes the at least one computing device to continually execute queued tasks using the one or more tools included in the set of downstream tools until completion of executing the workflow.

In some aspects, the techniques described herein relate to a system including: at least one processor; and a computer-readable storage medium storing instructions that, when executed by the at least one processor, cause the at least one processor to: receive a workflow configured to generate an output by processing data using a plurality of tools, the plurality of tools including a set of upstream tools and a set of downstream tools, the set of upstream tools configured to generate tasks for subsequent execution by one or more tools included in the set of downstream tools; execute the workflow by: generating the tasks using the set of upstream tools; maintaining the tasks in a queue; and generating the output by releasing individual ones of the tasks in the queue to the one or more tools included in the set of downstream tools; and during execution of the workflow: detect satisfaction of at least one throttle threshold condition due to maintaining the tasks in the queue; and throttle at least one tool in the set of upstream tools.

In some aspects, the techniques described herein relate to a computer-readable storage medium storing instructions that are executable by at least one processing device to perform operations including: receiving a workflow configured to generate an output by processing data using a plurality of tools, the plurality of tools including a set of upstream tools and a set of downstream tools, the set of upstream tools configured to generate tasks for subsequent execution by one or more tools included in the set of downstream tools; executing the workflow by: generating the tasks using the set of upstream tools; maintaining the tasks in a queue; and generating the output by releasing individual ones of the tasks in the queue to the one or more tools included in the set of downstream tools; and during the executing the workflow: detecting satisfaction of at least one throttle threshold condition due to maintaining the tasks in the queue; and throttling at least one tool in the set of upstream tools.

In the following discussion, an example environment is described that is configured to employ the techniques described herein. Example procedures are also described that are configured for performance in the example environment as well as other environments. Consequently, performance of the example procedures is not limited to the example environment and the example environment is not limited to performance of the example procedures.

### Example Environment

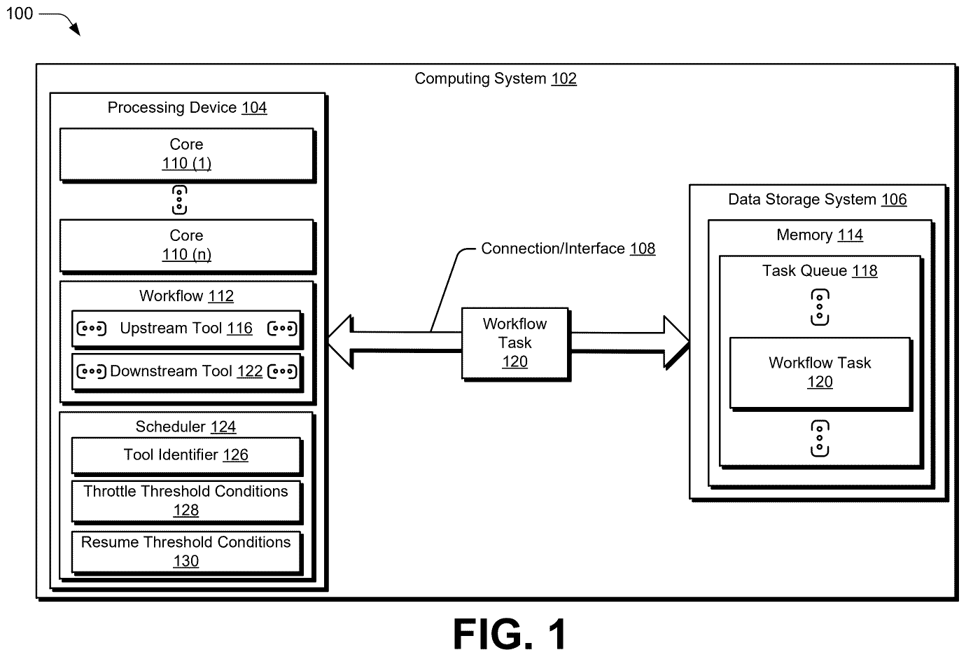

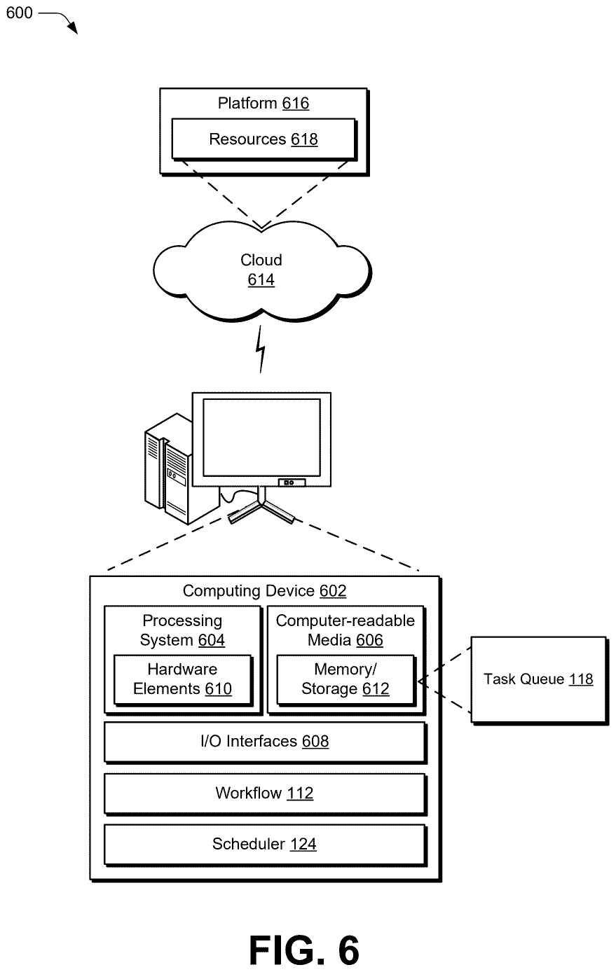

FIG. 1 is an illustration of a digital medium environment 100 in an example implementation that is operable to employ the selective throttling of workflow tool techniques described herein. The illustrated environment 100 includes a computing system 102. The computing system 102 is configurable in a variety of manners. A computing system, for instance, is configurable as a desktop computer, a laptop computer, a mobile device (e.g., assuming a handheld configuration such as a tablet or mobile phone), and so forth. Thus, a computing system ranges from full resource devices with substantial memory and processor resources (e.g., personal computers, game consoles) to a low-resource device with limited memory and/or processing resources (e.g., mobile devices). Additionally, although a single computing system is shown and described in instances in the following discussion, a computing system is also representative of a plurality of different devices, such as multiple servers utilized by an entity to perform operations “over the cloud,” as further described in relation to FIG. 6.

Computing system 102 is representative of a combination of hardware and software resources (e.g., instructions stored on a computer-readable storage medium that are executed by at least one processing device) to perform computational tasks. To do so, the computing system 102 includes at least one processing device 104 and a data storage system 106, where the processing device is connected to the data storage system 106 via connection/interface 108. In one or more implementations, the processing device 104 includes multiple cores 110. For instance, in the illustrated example of FIG. 1, processing device 104 is depicted as including core 110 (1) and core 110 (n), where n represents any integer. Cores 110 of the processing device 104 are configured to carry out workflow 112 by executing instructions corresponding to individual tools of the workflow using data stored in memory 114 of the data storage system 106. As described above, the workflow 112 includes at least one sequence of interconnected tools that collectively operate to achieve one or more objectives, such as generating an output by processing data stored in memory 114.

In accordance with the described techniques, the processing device 104 and the data storage system 106 are coupled to one another via a wired or wireless connection, which is depicted in the illustrated example of FIG. 1 as the connection/interface 108. Example wired connections include, but are not limited to, buses (e.g., a data bus), interconnects, traces, and planes. Examples of devices in which the computing system 102 is implemented include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

Processing device 104 is an electronic circuit that performs various operations on and/or using data in the memory 114. Examples of the processing device 104 and/or a core 110 of the processing device include, but are not limited to, a CPU, a GPU, a field programmable gate array (FPGA), an accelerated processing unit (APU), and a digital signal processor (DSP). For example, in one or more implementations a core 110 is a processing unit that reads and executes instructions (e.g., of a program involving at least one workflow), examples of which include to add data, to move data, to branch data, and so forth.

In one or more implementations, the data storage system 106 is a circuit board (e.g., a printed circuit board), on which the memory 114 is mounted. In some variations, one or more integrated circuits of the memory 114 are mounted on the circuit board of the data storage system 106. Examples of the data storage system 106 include, but are not limited to, a TransFlash memory module, a single in-line memory module (SIMM), and a dual in-line memory module (DIMM). In one or more implementations, the data storage system 106 is a single integrated circuit device that incorporates the memory 114 on a single chip. In some examples, the data storage system 106 is composed of multiple chips that implement the memory 114 that are vertically (“3D”) stacked together, are placed side-by-side on an interposer or substrate, or are assembled via a combination of vertical stacking or side-by-side placement.

The memory 114 is a device or system that is used to store information, such as for immediate use in a device (e.g., by a core 110 of the processing device 104). In one or more implementations, the memory 114 corresponds to semiconductor memory where data is stored within memory cells on one or more integrated circuits. In at least one example, the memory 114 corresponds to or includes volatile memory, examples of which include random-access memory (RAM), dynamic random-access memory (DRAM), synchronous dynamic random-access memory (SDRAM), and static random-access memory (SRAM).

In some implementations, the memory 114 corresponds to or includes a cache memory of the core 110 and/or the processing device 104 such as a level 1 cache, a level 2 cache, a level 3 cache, and so forth. For example, the memory 114 represents high bandwidth memory (HBM) in a 3D-stacked implementation. Alternatively or additionally, the memory 114 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). The memory 114 is thus configurable in a variety of ways without departing from the spirit or scope of the described techniques.

In the illustrated example of FIG. 1, the workflow 112 includes at least one upstream tool 116 that is configured to generate tasks for execution by at least one downstream tool of the workflow 112. To buffer tasks generated by an upstream tool 116, the memory 114 includes a task queue 118 that is configured to maintain workflow tasks generated by an upstream tool until sufficient computing system 102 resources are available for a downstream tool to execute a queued workflow task. For instance, in the illustrated example of FIG. 1, the task queue 118 maintains a workflow task 120 generated by an upstream tool 116 for subsequent execution by at least one downstream tool 122 of the workflow 112.

The processing device 104 is depicted as including a scheduler 124, which represents functionality of the computing system 102 to manage execution of the workflow 112 in accordance with the techniques described herein. To do so, the scheduler 124 includes a tool identifier 126 for recognizing specific workflow tools, as well as respective sets of throttle threshold conditions 128 and resume threshold conditions 130. As described above, the throttle threshold conditions 128 and the resume threshold conditions 130 are used by the scheduler to determine when to throttle or resume, respectively, at least one upstream tool 116 during execution of the workflow 112.

During execution of the workflow 112, the scheduler 124 monitors the task queue 118 relative to throttle threshold conditions 128. In accordance with the described techniques, throttle threshold conditions 128 refer to criteria that, when detected, trigger the scheduler 124 to throttle one or more upstream workflow tools 116 to manage task generation by the at least one upstream tool 116, and corresponding growth of tasks in the task queue 118. For instance, a throttle threshold condition may specify a predetermined limit of tasks 120 permitted to be maintained in the queue 118, or a total data size of queued tasks.

In response to detecting the occurrence of a throttle threshold condition 128, the scheduler 124 identifies an upstream workflow tool 116 contributing to occurrence of the throttle threshold conditions 128 and throttles the identified tool to reduce the number of tasks being generated and sent to the queue 118. As described herein, the scheduler 124 is configured to employ various strategies to identify such tools, including analyzing task generation rates, examining task metadata, considering the computational complexity of tasks generated by different tools, combinations thereof, and so forth.

After throttling one or more upstream workflow tools 116, the scheduler 124 continues to monitor the queue 118 for satisfaction of resume threshold conditions 130. In some implementations, the resume threshold conditions 130 are satisfied when the throttle threshold conditions 128 are not satisfied. Alternatively, in some implementations the resume threshold conditions 130 differ from throttle threshold conditions 128 (e.g., to prevent rapid oscillation between throttling and resuming operation of at least one upstream tool 116). When resume threshold conditions 130 are satisfied, the scheduler 124 initiates the process of “unthrottling,” or resuming normal operation of a previously throttled one upstream tool 116. Throughout execution of the workflow 112, the scheduler 124 maintains the ability to re-throttle tools as necessary (e.g., responsive to detecting satisfaction of throttle threshold conditions 128), ensuring optimal workflow execution and resource utilization by the computing system 102.

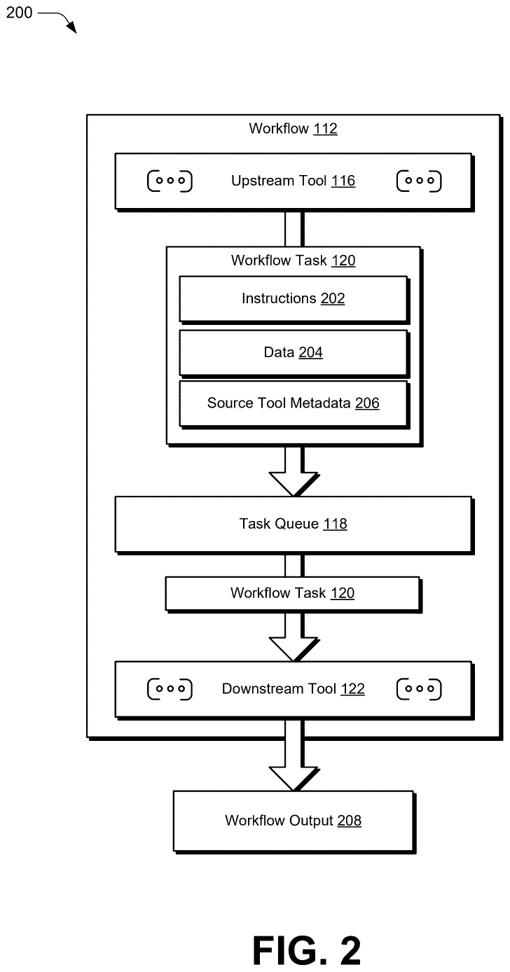

For a further description of the computing system 102 executing a workflow 112 and using the scheduler 124 to selectively throttle and resume at least one upstream tool 116 based on throttle threshold conditions 128 and resume threshold conditions 130, respectively, consider FIG. 2.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in diverse ways. Thus, individual functionality, features, and concepts described in relation to different example environments, devices, components, figures, and procedures herein are usable in any suitable combinations and are not limited to the particular combinations represented by the enumerated examples in this description.

### Example Selective Throttling of Workflow Tools

FIG. 2 depicts a system 200 in an example implementation showing operation of executing a workflow 112 in accordance with the techniques described herein. In the illustrated example of FIG. 2, the workflow 112 includes at least one upstream tool 116 that is configured to generate tasks for execution by at least one downstream tool 122. To buffer tasks generated by an upstream tool 116, the system 200 includes a task queue 118 that is configured to maintain workflow tasks generated by an upstream tool 116 until sufficient computing system resources are available for a downstream tool 122 to execute a queued workflow task.

For instance, FIG. 2 depicts the task queue 118 as maintaining a workflow task 120 generated by an upstream tool 116 for subsequent execution by at least one downstream tool 122. The workflow task 120 is representative of information including task instructions 202, which represent at least one instruction to be executed by a processing device of a computing system executing the workflow 112. The workflow task 120 is further representative of information specifying data 204, which corresponds to data stored in memory 114 that is accessed as part of executing the task instruction 202. Additionally, in some implementations the workflow task 120 includes information describing source tool metadata 206, is representative of information describing the upstream tool 116 that generated the workflow task 120.

During execution of the workflow 112, the scheduler 124 monitors the task queue 118 relative to throttle threshold conditions 128. When the scheduler 124 detects satisfaction of at least one throttle threshold condition 128, the scheduler 124 identifies an upstream tool 116 contributing to occurrence of the throttle threshold condition (e.g., based on respective source tool metadata 206 associated with workflow tasks 120 maintained in the task queue 118). The scheduler 124 then throttles the identified upstream tool 116 to reduce an amount of tasks being generated and sent to the task queue 118.

As individual workflow tasks 120 are released from the task queue 118 to appropriate downstream tools 122, the respective downstream tools execute the task instructions 202 using the associated data 204 to generate a workflow output 208. The scheduler continues to monitor the task queue 118 for satisfaction of resume threshold conditions. When resume threshold conditions are satisfied, the scheduler 124 resumes normal operation of previously throttled upstream tools 116.

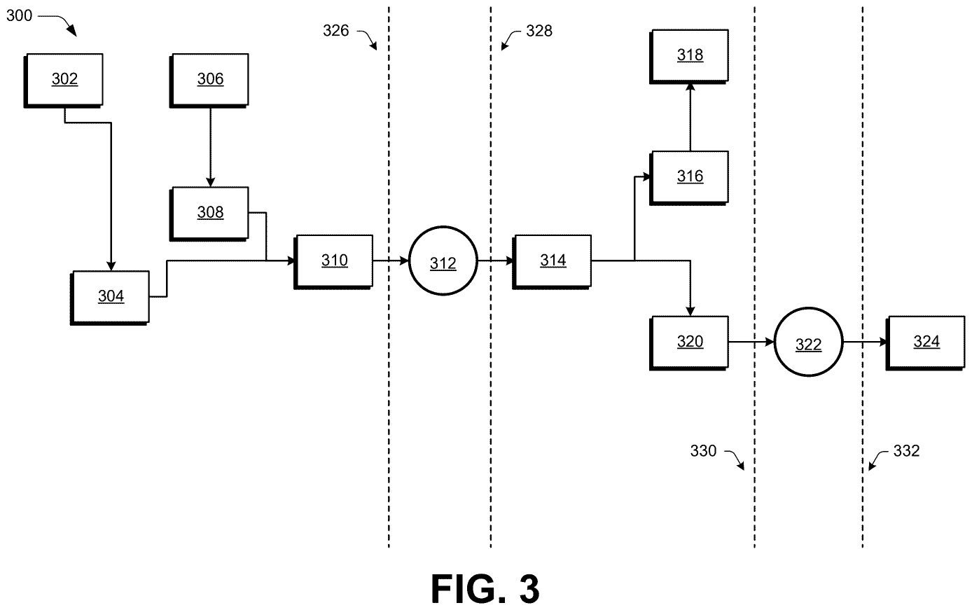

This process of selectively throttling and resuming upstream tools 116 based on monitored queue conditions allows the system 200 to optimize workflow execution and resource utilization. By dynamically managing task generation and queue growth, the system 200 ensures efficient processing of workflow tasks 120 while preventing queue overflow and maintaining overall system performance throughout execution of the workflow 112. For a further description of executing a workflow in accordance with the described techniques, consider FIG. 3.

FIG. 3 depicts a system 300 illustrating an example workflow structure with multiple interconnected tools and task queues. Specifically, the workflow illustrated in FIG. 3 includes tool 302, tool 304, tool 306, tool 308, tool 310, task queue 312, tool 314, tool 316, tool 318, tool 320, task queue 322, and tool 324. The illustrated example of FIG. 3 further depicts logical boundaries, represented by first boundary 326, second boundary 328, third boundary 330, and fourth boundary 332, to demonstrate how workflow tools are regarded as upstream or downstream based on their position relative to tasks maintained in a corresponding one of task queue 312 or task queue 322. Thus, the logical boundaries depicted in FIG. 3 are generally representative of various stages or functional regions of a workflow 112.

In the illustrated example, task queue 312 is configured to maintain tasks output by one or more of tool 302, tool 304, tool 306, tool 308, or tool 310 (e.g., for subsequent execution by one or more of tool 314, tool 316, tool 318, tool 320, or tool 324). Thus, workflow tools depicted to the left of the first boundary 326 are upstream tools relative to tasks maintained in the task queue 312. Similarly, workflow tools depicted to the right of the second boundary 328 are downstream tools relative to tasks maintained in the task queue 312.

In the illustrated example of FIG. 3, the task queue 322 is configured to maintain tasks output by one or more of tool 302, tool 304, tool 306, tool 308, tool 310, tool 314, or tool 320 (e.g., for subsequent execution by tool 324). Thus, workflow tools depicted to the left of the third boundary 330 are upstream tools relative to tasks maintained in the task queue 322. Similarly, workflow tools depicted to the right of the fourth boundary 332 (e.g., tool 324) are downstream tools relative to tasks maintained in the task queue 322. In this manner, individual tools of a workflow can be regarded as either an upstream tool 116 or a downstream tool 122, depending on a queued task. For instance, tool 314 is a downstream tool relative to a task maintained in task queue 312 and is an upstream tool relative to a task maintained in task queue 322.

The workflow structure illustrated in FIG. 3 is thus representative of how the described throttling and resuming techniques can be applied in a multi-queue, multi-tool workflow environment. The scheduler 124 is configured to monitor both task queue 312 and task queue 322, and to further apply different throttling strategies to the respective upstream tools based on the state of each queue and the overall workflow performance. For example, if queue 312 becomes congested, the scheduler might throttle tools 302, 304, 306, 308, or 310 selectively, while continuing to allow full operation of tools feeding into queue 322.

In the context of FIG. 3, each individual tool depicted may represent a complex processing unit capable of parallel execution across multiple cores 110 of the computing system 102. For instance, a single tool, such as tool 302, may be configured to utilize up to n cores 110 simultaneously. This parallel processing capability allows a single tool to produce up to n outputs per clock cycle of the computing system 102, significantly amplifying its task generation or processing capacity. As a result, even workflows 112 that appear relatively simple in structure, with only a few upstream tools 116, can rapidly generate a large volume of tasks.

For example, if tool 302 utilizes all n cores in parallel, it could potentially produce n tasks per clock cycle, quickly populating the task queue 312. Similarly, downstream tools (e.g., downstream tool 314) could consume and process multiple tasks simultaneously, potentially at a rate of n tasks per clock cycle. This parallel processing capability at the tool level results in workflows with seemingly few components quickly leading to queue congestion, necessitating the dynamic throttling and resuming mechanisms described herein. The ability of individual workflow tools to leverage multiple compute units (e.g., processor cores) highlights the importance of efficient queue management and task scheduling in maintaining optimal workflow performance, especially in high-performance computing environments where the number of available cores n may be substantial, which is impossible using conventional workflow management techniques.

The system 300 demonstrates the flexibility and scalability of the workflow management approach, showing how it can handle complex, non-linear task flows with multiple points of potential congestion and varied resource requirements. By applying the throttling and resuming techniques at each queue, the system can maintain optimal performance across the entire workflow, balancing task generation and execution across various stages and branches of the process.

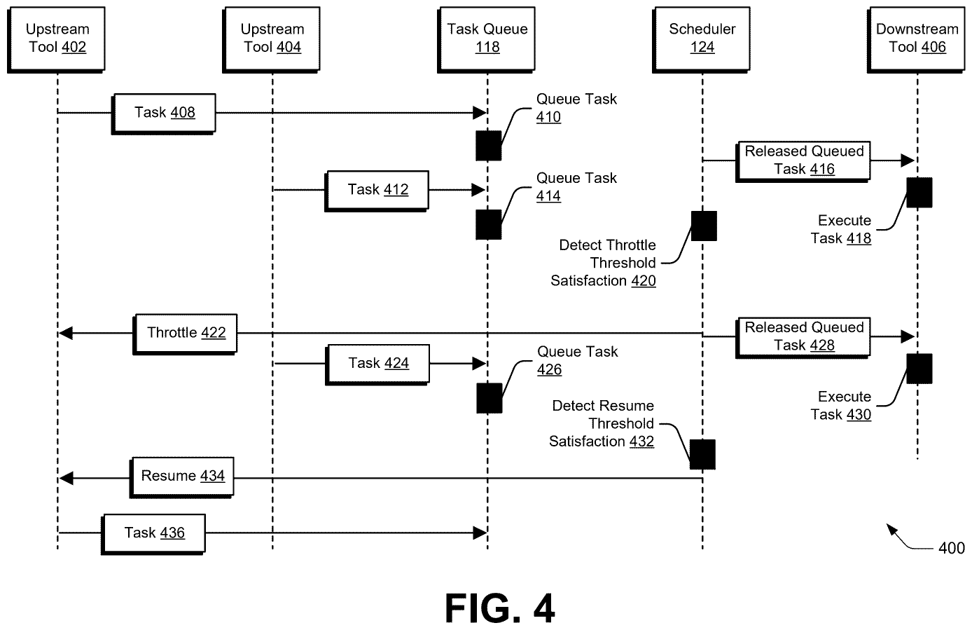

FIG. 4 depicts a system 400 in an example implementation showing operation of the scheduler 124 as selectively throttling and resuming tools during execution of a workflow. Specifically, in the illustrated example of FIG. 4, the workflow includes upstream tool 402, upstream 404, task queue 118, scheduler 124, and downstream tool 406 to demonstrate a flow of tasks and throttle/resume signals during execution of a workflow 112.

To begin, upstream tool 402 generates task 408 and sends task 408 to task queue 118. Task queue 118 then queues task 408 at block 410. Similarly, upstream tool 404 generates task 412 and sends task 412 to task queue 118. Task queue 118 then queues task 412 at block 414. In the illustrated example, task 408 and task 412 are each representative of an example instance of workflow task 120. In this manner, FIG. 4 depicts how multiple upstream tools 116 are configured to feed tasks (e.g., in parallel, in series, or combinations thereof) into a single task queue 118 during execution of a workflow 112.

The scheduler 124 is configured to monitor system resources (e.g., of computing system 102) and identify when sufficient resources are available to release a task maintained in task queue 118 for execution by downstream tool 406. For instance, in response to detecting that a core 110 is available to execute task 408, the scheduler 124 releases task 408 for execution by downstream tool 406, illustrated in FIG. 4 as released queued task 416. Releasing task 408 for execution by the downstream tool 406 causes the downstream tool 406 to execute task 408, represented by block 418 in the illustrated example of FIG. 4. In response to releasing a task from the task queue 118, the scheduler 124 is further configured to remove an entry in the task queue 118 corresponding to the released task. In some implementations, the scheduler 124 monitors the downstream tool 406 to determine that the task was successfully executed before removing the task from the task queue 118.

As depicted in the illustrated example of FIG. 4, during execution of the workflow 112, the scheduler 124 detects satisfaction of one or more throttle threshold conditions 128 (block 420). In response to detecting satisfaction of one or more throttle threshold conditions 128, the scheduler 124 identifies an upstream tool 116 that is contributing to satisfaction of the throttle threshold conditions 128. In one example implementation, the scheduler 124 analyzes task generation rates of individual upstream tools (e.g., upstream tool 402 and upstream tool 404) and compares the task generation rates to determine which tool is producing tasks at a disproportionately high rate relative to others.

Alternatively or additionally, the scheduler 124 is configured to examine metadata associated with queued tasks, allowing the scheduler 124 to pinpoint tools contributing most significantly to task queue 118 congestion. Alternatively or additionally, the scheduler 124 considers the computational complexity or resource requirements of tasks generated by upstream tool 402 and upstream tool 404, prioritizing the identification of an upstream tool 116 producing resource-intensive tasks that strain computing system 102 capabilities. Alternatively or additionally, historical performance data is utilized to identify tools that have previously led to queue overflows (e.g., during prior execution of workflows involving similar tools). Alternatively or additionally, the scheduler 124 is configured to consider the relative importance or priority of different workflow stages, focusing on non-critical path tools when possible, to minimize impact on overall workflow performance.

Alternatively or additionally, the scheduler 124 is configured to employ machine learning algorithms to predict whether throttling upstream tool 402 or upstream tool 404 would most effectively alleviate task queue 118 congestion based on current workflow patterns and resource availability of computing system 102. Alternatively or additionally, the scheduler 124 is configured to analyze current system resource utilization associated with operation of upstream tool 402 and upstream tool 404, respectively, identifying one or more tools consuming excessive resources as potential candidates for throttling. In the illustrated example of FIG. 4, scheduler 124 identifies upstream tool 402 as being a primary contributor to satisfying the throttle threshold conditions 128 and issues a throttle command 422 to the upstream tool 402.

The throttle command 422 causes throttling of the upstream tool 402, which is representative of pausing operation of upstream tool 402 or reducing a rate at which upstream tool 402 is permitted to generate tasks, allowing upstream tool 402 to continue functioning at a slower pace. While the upstream tool 402 is throttled, implementations permit at least one other upstream tool 116 to continue generating tasks for output to the task queue 118. For instance, the illustrated example of FIG. 4 depicts a scenario where upstream tool 404 is permitted to continue generating tasks while upstream tool 402 is throttled, represented by the issuance of task 424 to task queue 118 and queueing of task 424 (block 426). Thus, the scheduler 124 is configured to throttle one or more upstream tools independent of (e.g., without) throttling an entirety of the upstream tools relative to a task queue.

While upstream tool 402 is throttled, the scheduler 124 continues to release tasks from the task queue 118 for execution by downstream tool 406, as represented by the released queued task 428 and subsequent execution of the released queued task 428 by the downstream tool 406 (block 430). Although only a single task 424 is depicted as being generated and queued while the upstream tool 402 is throttled, this illustrated example is not so limiting and any number of upstream tools 116 may be permitted to generate any number of tasks for maintenance in task queue 118, in accordance with the described techniques. Similarly, although only a single released queued task 428 is depicted as being executed by the downstream tool 406 while the upstream tool 402 is throttled, this example is not so limiting and any number of tasks may be released from the task queue 118 and executed by the downstream tool 406 until satisfaction of resume threshold conditions 130.

Upstream tool 402 remains throttled until the scheduler 124 detects satisfaction of resume threshold conditions 130, represented in the illustrated example of FIG. 4 by block 432. In response to detecting that one or more resume threshold conditions 130 are satisfied, the scheduler 124 issues a resume command 434 to the throttled upstream tool 402, which represents a degree of “unthrottling” upstream tool 402 from its throttled state (e.g., at least partially permitting the upstream tool 402 to resume generating tasks at full capacity and without limitation by the scheduler 124). Unthrottling of the upstream tool 402 is represented by generation of task 436, which is sent to the task queue 118, and execution of the workflow 112 continues until all queued tasks have been released for execution by the downstream tool 406.

Although described herein in the context of static (e.g., predefined and unchanging) threshold conditions for throttling a workflow tool and resuming a workflow tool, in some implementations the scheduler 124 is configured to dynamically modify at least one of the throttle threshold conditions 128 or the resume threshold conditions 130 during execution of the workflow 112 based on various factors related to the current state of the computing system 102 and the workflow itself. This dynamic adjustment allows for more adaptive and efficient management of task generation and execution, particularly in complex or rapidly changing computing environments.

For instance, in some implementations the scheduler 124 is configured to modify at least one of the throttle threshold conditions 128 or the resume threshold conditions 130 based on a number of tools included in the set of upstream tools 116. For instance, if a number of active upstream tools increases during workflow execution, the scheduler 124 is configured to adjust at least one throttle threshold condition 128 to a lower value, triggering throttling earlier to prevent queue overflow. Conversely, if some upstream tools 116 complete their task generation and become inactive, the scheduler 124 is configured to increase at least one throttle threshold condition 128, allowing remaining upstream tools to generate tasks more freely.

The number of available processing devices, such as processor cores or compute units, may also impact threshold adjustments. For instance, if the scheduler 124 detects that additional processing resources become available (e.g., due to completion of other workflow tasks, system processes, combinations thereof, and so forth), the scheduler 124 may increase throttle threshold conditions 128 and reduce resume threshold conditions 130, allowing for more aggressive task generation and queuing. Conversely, if processing resources become constrained, the scheduler 124 is configured to lower throttle threshold conditions 128 and increase resume threshold conditions 130 to maintain system stability and prevent resource exhaustion.

Available memory is another critical factor in adjusting one or more of the throttle threshold conditions 128 or the resume threshold conditions 130. As available memory 114 fluctuates during workflow execution, the scheduler 124 is configured to modify threshold conditions accordingly. For example, if memory usage approaches a defined threshold capacity, the scheduler 124 is configurable to reduce one or more throttle threshold conditions 128 and/or raise one or more resume threshold conditions 130, effectively creating a larger buffer between the two conditions. This adjustment helps prevent memory overflow while ensuring efficient use of available resources.

In implementations, the scheduler 124 may also consider the relative position of upstream tools 116 within the workflow 112 (e.g., a distance between an upstream tool 116 and a task queue 118) when adjusting one or more of the throttle threshold conditions 128 or the resume threshold conditions 130. For tools that are further “upstream” (i.e., tools that generate tasks which are required to pass through multiple intermediate upstream tools before reaching the task queue 118), the scheduler 124 may apply more aggressive throttling by lowering one or more of the throttle threshold conditions 128. This approach helps prevent bottlenecks in complex, multi-stage workflows by managing task generation at earlier stages. Conversely, for upstream tools closer to the task queue 118, the scheduler 124 is configured to allow higher throttle threshold conditions 128, enabling more immediate task availability for processing by a downstream tool 122.

Having considered example systems and techniques for selectively throttling workflow tools, consider now example procedures to illustrate aspects of the techniques described herein.

### Example Procedures

The following discussion describes techniques that are configured to be implemented utilizing the systems and devices described herein. Aspects of each of the procedures are configured for implementation in hardware, firmware, software, or a combination thereof. The procedures are shown as a set of blocks that specify operations performed by one or more devices and are not limited to the orders shown for performing the operations by the respective blocks. In portions of the following discussion, reference is made to FIGS. 1-4.

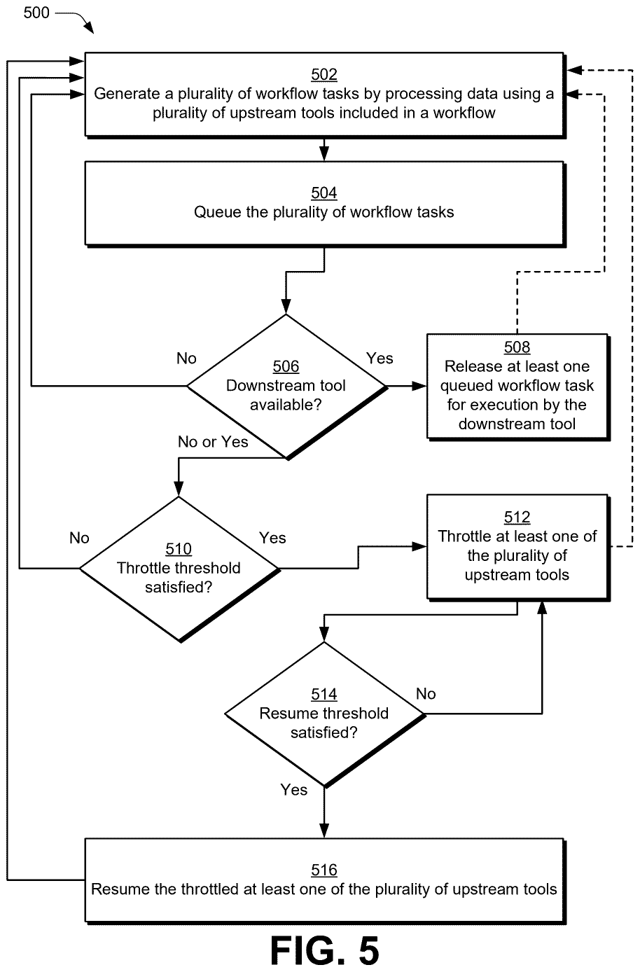

FIG. 5 depicts a procedure 500 in an example implementation of selectively throttling workflow tools during execution of a workflow. To begin, a plurality of workflow tasks are generated by processing data using a plurality of upstream tools included in a workflow (block 502). The computing system 102, for instance, receives workflow 112 as including one or more upstream tools (e.g., upstream tool 116) and one or more downstream tools (e.g., downstream tool 122) relative to at least one task queue 118. As part of executing the workflow 112, the computing system 102 generates at least one workflow task 120 using at least one upstream tool 116.

As part of executing the workflow, the plurality of workflow tasks are queued (block 504). The upstream tool 116, for instance, outputs workflow task 120 to task queue 118 for buffering until one or more downstream tools 122 are available to execute the workflow task 120.

While one or more workflow tasks 120 are maintained in the task queue 118, a determination is made as to whether a corresponding downstream tool is available to execute a queued workflow tasks (block 506). If no downstream tools are available to execute a queued workflow task 120 (e.g., a “No” determination at block 506), operation of the procedure 500 returns to block 502 and one or more upstream tools 116 continue to generate tasks for maintenance in the task queue 118 until a corresponding downstream tool 122 is available.

Alternatively, in response to detecting that a downstream tool is available to execute a queued workflow task (e.g., a “Yes” determination at block 506), at least one queued workflow task is released for execution by the corresponding available downstream tool (block 508). The scheduler 124, for instance, monitors the task queue 118 and hardware resources of the computing system 102 to identify when the downstream tool 406 is available to execute task 408 and releases task 408 to the downstream tool 406 for execution in response to detecting that sufficient hardware resources are available. Operation then optionally returns to block 502 to generate and/or execute one or more additional workflow tasks, as indicated by the dashed arrow returning to block 502 from block 508. In this manner, the procedural flow of block 502, block 504, block 506, and block 508 continues until execution of the workflow 112 is complete.

During execution of the workflow, both when a downstream tool is available to execute a queued workflow task and when the downstream tool is unavailable to execute the queued workflow task, a determination is made as to whether a throttle threshold is satisfied (block 510). The scheduler 124, for instance, monitors the task queue 118 and hardware resource consumption by the computing system 102 to determine whether one or more throttle threshold conditions 128 are satisfied during execution of the workflow 112. If no throttle threshold conditions are satisfied (e.g., a “No” determination at block 510), operation of procedure 500 continues by generating tasks using upstream tools 116 as part of executing the workflow, represented by the arrow returning to block 502 from block 510.

Alternatively, in response to detecting that at least one throttle threshold condition is satisfied (e.g., a “Yes” determination at block 510), at least one of the plurality of upstream tools is throttled (block 512). The scheduler 124, for instance, identifies upstream tool 402 as contributing to satisfaction of the throttle threshold condition 128 and issues a throttle command 422 to the identified upstream tool 402.

After throttling an upstream tool 116, a determination is made as to whether a resume threshold is satisfied (block 514). The scheduler 124, for instance, continues to monitor the task queue 118 and hardware resource consumption by the computing system 102 to determine whether one or more resume threshold conditions 130 are satisfied. If no resume threshold conditions are satisfied (e.g., a “No” determination at block 514), operation of procedure 500 continues by maintaining the throttle on the identified upstream tool 116 while releasing queued tasks for execution by available downstream tools 122, as represented by the arrow returning to block 508 from block 514.

Alternatively, in response to detecting that at least one resume threshold condition is satisfied (e.g., a “Yes” determination at block 514), the throttled upstream tool is resumed (block 516). The scheduler 124, for instance, issues a resume command 434 to the previously throttled upstream tool 402, allowing the upstream tool 402 to resume normal task generation. Operation then returns to block 502 to continue generating and executing workflow tasks with upstream tools 116 operating at full capacity.

Having described example procedures in accordance with one or more implementations, consider now an example system and device to implement the various techniques described herein.

### Example System and Device

FIG. 6 illustrates an example system 600 that includes an example computing device 602 that is representative of one or more computing systems and/or devices that implement the various techniques described herein. This is illustrated through inclusion of the workflow 112, the task queue 118, and the scheduler 124. The computing device 602 is configurable, for example, as a server of a service provider, a device associated with a client (e.g., a client device), an on-chip system, and/or any other suitable computing device or computing system.

The example computing device 602 as illustrated includes a processing device 604, one or more computer-readable media 606, and one or more I/O interface 608 that are communicatively coupled, one to another. Although not shown, the computing device 602 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 604 is representative of functionality to perform one or more operations using hardware. Accordingly, the processing device 604 is illustrated as including hardware element 610 that is configurable as processors, functional blocks, and so forth. This includes implementation in hardware as an application specific integrated circuit or other logic device formed using one or more semiconductors. The hardware elements 610 are not limited by the materials from which they are formed, or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 606 is illustrated as including memory/storage 612 that stores instructions that are executable to cause the processing device 604 to perform operations. The computer-readable storage medium is configured for storing instructions that, responsive to execution by the processing device, causes the processing device to perform operations. The memory/storage 612 represents memory/storage capacity associated with one or more computer-readable media. The memory/storage 612 includes volatile media (such as random-access memory (RAM)) and/or nonvolatile media (such as read only memory (ROM), Flash memory, optical disks, magnetic disks, and so forth). The memory/storage 612 includes fixed media (e.g., RAM, ROM, a fixed hard drive, and so on) as well as removable media (e.g., Flash memory, a removable hard drive, an optical disc, and so forth). The computer-readable media 606 is configurable in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 602. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 602, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 610. The computing device 602 is configured to implement particular instructions and/or functions corresponding to the software and/or hardware modules. Accordingly, implementation of a module that is executable by the computing device 602 as software is achieved at least partially in hardware, e.g., through use of computer-readable storage media and/or hardware elements 610 of the processing device 604. The instructions and/or functions are executable/operable by one or more articles of manufacture (for example, one or more computing devices 602 and/or processing devices 604) to implement techniques, modules, and examples described herein.

The techniques described herein are supported by various configurations of the computing device 602 and are not limited to the specific examples of the techniques described herein. This functionality is also implementable all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 include applications and/or data that can be utilized while computer processing is executed on servers that are remote from the computing device 602. Resources 618 can also include services provided over the Internet and/or through a subscriber network, such as a cellular or Wi-Fi network.

The platform 616 abstracts resources and functions to connect the computing device 602 with other computing devices. The platform 616 also serves to abstract scaling of resources to provide a corresponding level of scale to encountered demand for the resources 618 that are implemented via the platform 616. Accordingly, in an interconnected device embodiment, implementation of functionality described herein is distributable throughout the system 600. For example, the functionality is implementable in part on the computing device 602 as well as via the platform 616 that abstracts the functionality of the cloud 614.

In implementations, the platform 616 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by at least one computing device, the method comprising:
receiving a workflow configured to generate an output by processing data using a plurality of tools, the plurality of tools including a set of upstream tools and a set of downstream tools, the set of upstream tools configured to generate tasks for subsequent execution by one or more tools included in the set of downstream tools;
executing the workflow by:
generating the tasks using the set of upstream tools;
maintaining the tasks in a queue; and
generating the output by releasing individual ones of the tasks in the queue to the one or more tools included in the set of downstream tools; and
during the executing the workflow:
detecting satisfaction of at least one throttle threshold condition due to maintaining the tasks in the queue; and
throttling at least one tool in the set of upstream tools.

2. The method of claim 1, wherein generating the tasks for subsequent execution by the one or more tools included in the set of downstream tools comprises processing the data, wherein each of the tasks for subsequent execution by the one or more tools included in the set of downstream tools includes:
at least one instruction to be executed by a processing device of the at least one computing device; and
information describing at least some of the data involved in executing the at least one instruction.

3. The method of claim 2, wherein each of the tasks for subsequent execution by the one or more tools included in the set of downstream tools is maintained in the queue with information describing a source tool in the set of upstream tools that generated the task.

4. The method of claim 3, wherein throttling the at least one tool in the set of upstream tools comprises identifying the at least one tool as causing satisfaction of the at least one throttle threshold condition based on the information describing, for each of the tasks maintained in the queue, a corresponding source tool that generated the task.

5. The method of claim 1, wherein releasing individual ones of the tasks in the queue to the one or more tools included in the set of downstream tools is performed responsive to detecting that the at least one computing device includes sufficient available resources for executing the individual ones of the tasks.

6. The method of claim 5, wherein the sufficient available resources comprise a threshold number of available processing devices.

7. The method of claim 5, wherein the sufficient available resources comprise a threshold amount of memory allocated to the at least one computing device.

8. The method of claim 1, wherein throttling the at least one tool in the set of upstream tools comprises identifying the at least one tool in the set of upstream tools as disproportionately generating tasks relative to other tools of the set of upstream tools during execution of the workflow.

9. The method of claim 1, wherein throttling the at least one tool in the set of upstream tools comprises pausing the at least one tool in the set of upstream tools.

10. The method of claim 1, wherein throttling the at least one tool in the set of upstream tools comprises limiting an amount of tasks the at least one tool is permitted to generate or limiting a rate at which the at least one tool is permitted to generate tasks.

11. The method of claim 1, wherein throttling the at least one tool in the set of upstream tools is performed independent of throttling other tools in the set of upstream tools.

12. The method of claim 1, further comprising detecting satisfaction of at least one resume threshold and causing the at least one tool in the set of upstream tools to continue functioning without throttling in response to detecting satisfaction of the at least one resume threshold.

13. The method of claim 12, wherein the at least one resume threshold comprises one or more of:
a number of tasks maintained in the queue;
an amount of data required by the tasks maintained in the queue;
a number of available processing devices;
an amount of available memory; or
a temperature of the at least one computing device.

14. The method of claim 12, further comprising dynamically modifying the at least one resume threshold during the executing the workflow based on one or more of:
a number of tools included in the set of upstream tools;
a number of available processing devices;
an amount of available memory;
a distance between the throttled at least one upstream tool relative to the queue in the workflow; or
a distance between at least one downstream tool in the set of downstream tools relative to the queue in the workflow.

15. The method of claim 1, wherein the at least one throttle threshold condition comprises one or more of:
a number of tasks maintained in the queue;
an amount of data required by the tasks maintained in the queue;
a number of available processing devices;
an amount of available memory; or
a temperature of the at least one computing device.

16. The method of claim 1, further comprising dynamically modifying the at least one throttle threshold condition during the executing the workflow based on one or more of:
a number of tools included in the set of upstream tools;
a number of available processing devices;
an amount of available memory;
a distance between the throttled at least one upstream tool relative to the queue in the workflow; or
a distance between at least one downstream tool in the set of downstream tools relative to the queue in the workflow.

17. The method of claim 1, further removing the individual ones of the tasks from the queue in response to releasing the individual ones of the tasks from the queue to the one or more tools included in the set of downstream tools.

18. The method of claim 12, wherein the at least one resume threshold causes the at least one computing device to continually execute queued tasks using the one or more tools included in the set of downstream tools until completion of executing the workflow.

19. A system comprising:
at least one processor; and
a computer-readable storage medium storing instructions that, when executed by the at least one processor, cause the at least one processor to:
receive a workflow configured to generate an output by processing data using a plurality of tools, the plurality of tools including a set of upstream tools and a set of downstream tools, the set of upstream tools configured to generate tasks for subsequent execution by one or more tools included in the set of downstream tools;
execute the workflow by:
generating the tasks using the set of upstream tools;
maintaining the tasks in a queue; and
generating the output by releasing individual ones of the tasks in the queue to the one or more tools included in the set of downstream tools; and
during execution of the workflow:
detect satisfaction of at least one throttle threshold condition due to maintaining the tasks in the queue; and
throttle at least one tool in the set of upstream tools.

20. A computer-readable storage medium storing instructions that are executable by at least one processing device to perform operations comprising:
receiving a workflow configured to generate an output by processing data using a plurality of tools, the plurality of tools including a set of upstream tools and a set of downstream tools, the set of upstream tools configured to generate tasks for subsequent execution by one or more tools included in the set of downstream tools;
executing the workflow by:
generating the tasks using the set of upstream tools;
maintaining the tasks in a queue; and
generating the output by releasing individual ones of the tasks in the queue to the one or more tools included in the set of downstream tools; and
during the executing the workflow:
detecting satisfaction of at least one throttle threshold condition due to maintaining the tasks in the queue; and
throttling at least one tool in the set of upstream tools.
